(19) United States
(12) Patent Application Publication
(10) Pub. No.: US 2010/0260447 A1
(43) Pub. Date: Oct. 14, 2010

(54) BEARING ARRANGEMENT

(76) Inventors: Ferdinand Schweitzer, St. Peter in der Au (AT); Kjell Klintenstedt, Saltsjo-Boo (SE)

Correspondence Address: SKF USA Inc., 890 Forty Foot Road, PO Box 352, Lansdale, PA, 19446, US

(21) Appl. No.: 12/452,600

(22) PCT Filed: Jul. 9, 2007
(86) PCT No.: PCT/EP2007/006078

§ 371 Date: Jun. 22, 2010

(51) Int. Cl. F16C 33/10; F16C 17/00

(52) U.S. Cl. 384/8; 384/13

(57) ABSTRACT

The invention relates to a bearing arrangement (1), comprising at least one grease-lubricated bearing (2, 3) with a bearing region (4, 5) where rolling elements or a sliding element (6, 7) are arranged. To improve the assembly and the lubrication of the bearing arrangement, the invention is characterized in that at least one oil-collecting element (8, 9) is arranged near the bearing (2, 3), wherein a transport element (10, 11) connects the oil-collecting element (8, 9) with the bearing region (4, 5).

The invention relates to a bearing arrangement, comprising at least one grease-lubricated bearing with a bearing region where rolling elements or a sliding element are arranged.

Bearing arrangements of this kind are well known in the state of the art. To ensure an only small amount of maintenance work the bearings of the bearing arrangement can be filled with a certain amount of grease which ensures a sufficient operation time of the bearings until maintenance activities are necessary. It is aimed for some applications that the supply with lubricant is sufficient for the whole lifetime of the bearing arrangement. Therefore a lubrication using grease is well known in the art.

A problem of grease-lubricated bearings is that basis oil of the grease often drops out after a certain operation time of the bearing or a certain time of standstill. Consequently, the ability of the grease to lubricate the bearing deteriorates. This can even not be prevented when sealing elements are employed which should keep the oil in the bearing which drops out of the grease.

Therefore, it is an object of the invention to improve the lubrication of a bearing arrangement of the above mentioned kind so that it becomes possible to further minimize the necessary actions for maintenance of the bearing. It is aimed to supply the bearing with a filling of grease which is sufficient for the whole lifetime of the bearing arrangement. Furthermore, it should be possible to assemble the proposed device in an easy way.

The solution of this object according to the invention is characterized in that at least one oil-collecting element is arranged near the bearing, wherein a transport element connects the oil-collecting element with the bearing region.

Preferably, the transport element and/or the oil-collecting element consists of a porous material. Here, a ceramic material is preferred; the porous material can be e.g. aluminum oxide (Al₂O₃) or zirconium oxide (ZrC₂).

To further improve the lubrication of the bearings arrangement, at least one oil reservoir can be arranged near the bearing. The oil reservoir can be sensitive with respect to vibrations of the bearing arrangement. Specifically, the oil reservoir can be construed to emit oil when the bearing arrangement is excited with vibrations above a defined level of intensity. This is typically the case when running up the arrangement.

The bearing arrangement can bear a shaft element relatively to a housing. In this case, the axis of the shaft element can be arranged vertically, as it is typically for separators as used e. g. in the food industry. The oil-collecting element can be arranged below the bearing. The oil reservoir can be arranged above the bearing.

The shaft element can consists of aluminium and the housing can consists of steel.

Preferably, two bearings can be arranged, wherein both bearings are angular contact ball bearings. In this case the angle of both angular contact ball bearings can be different; specifically the angle of the upper angular contact ball bearings can be between 10° and 20° and the angle of the lower angular contact ball bearings can be between 25° and 35°.

At least one bearing can have at least one sensor element to survey at least one operation parameter; the parameter can be e. g. the temperature or the magnitude of vibrations. The at least one sensor element is preferably in wireless contact with a survey station for surveying the at least one operation parameter.

The preferred application for the proposed bearing arrangement is a separator, especially in the food industry. But the proposed bearing arrangement is also advantageously useable in other applications for liquid- and/or gas-separation such as separation of fuel or lubricating oil chemical substances cleaning of for instance oil contaminated water.

The invention makes sure that the deficiencies do not become effective when basis oil drops out from the grease by which the bearings are lubricated, which takes place especially after a long time of standstill. So, a loss of ability of lubrication of the grease is prevented.

The drawings show embodiments of the invention.

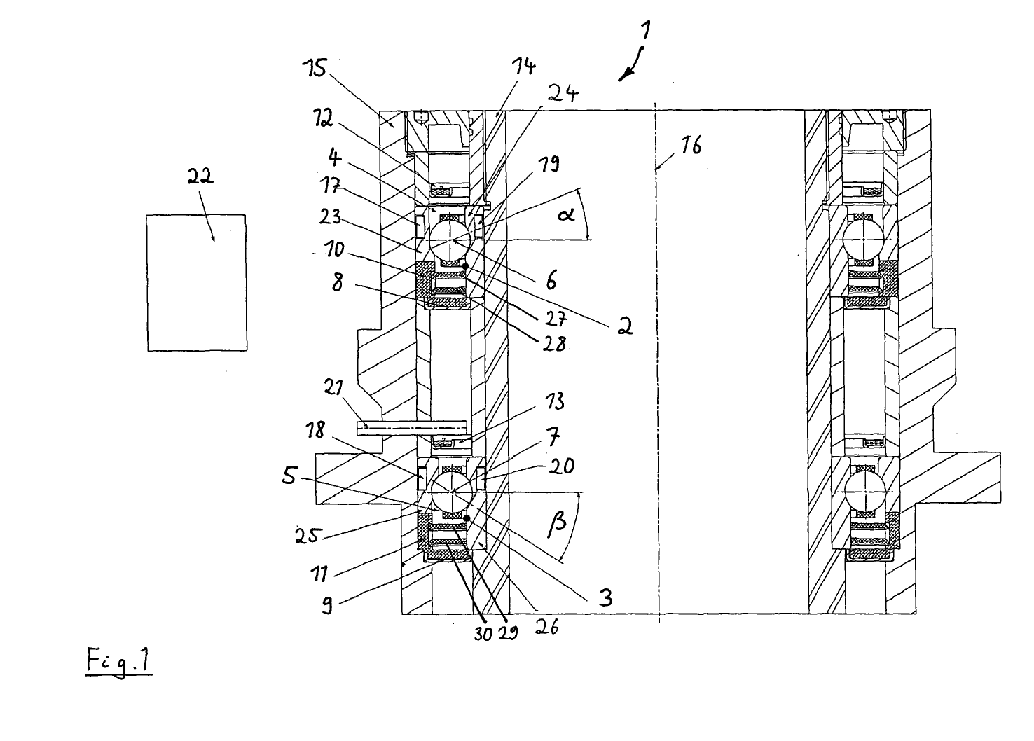

FIG. 1 shows a cross section of a bearing arrangement of a separator for the food industry according to a first embodiment of the invention,

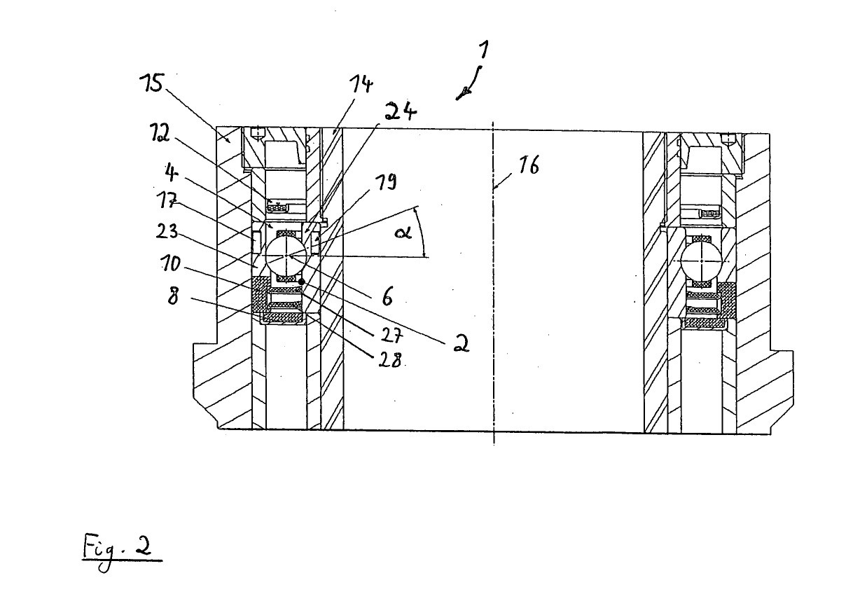

FIG. 2 shows the depiction of FIG. 1 with an alternative design of the invention and

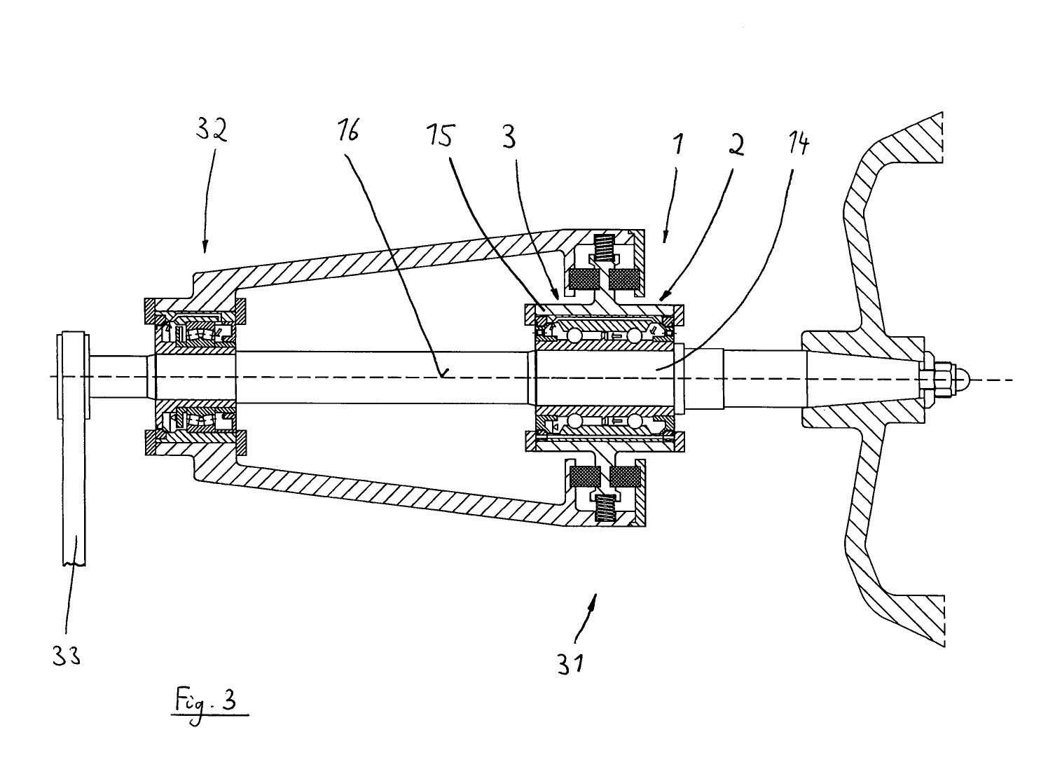

FIG. 3 shows the cross section of a separator.

In FIG. 1 a bearing arrangement 1 is shown which bears a shaft element 14 relatively to a housing 15. The axis 16 of the shaft element 14 is arranged vertically; this is typically for a separator. The bearing arrangement 1 has two annular contact ball bearing 2, 3 which are grease-lubricated. This means that a certain amount of grease in inserted into the bearing regions 4, 5. The bearing regions 4, 5 are those regions where the relevant bearing elements are located. In the case of the depicted embodiment of the invention the relevant bearing elements are the rolling elements 6, 7 (balls) of the bearings 2, 3 which are arranged between inner rings 24, 26 and outer rings 23, 25.

As can be seen from FIG. 1 both bearings 2, 3 have a certain pressure angle α and β respectively, which are not equal. The upper bearing 2 has a smaller angel α (preferably 15°) than the lower bearings 3, which has the angel β (preferably 30°). The difference between both angles α, β can be up to 15°.

Below the bearings 2, 3 an oil-collecting element 8, 9 is located. This oil-collecting element 8, 9 collects oil which leaves the bearings 2, 3 in spite of the sealing elements 27, 28, 29 and 30 which are arranged to prevent the leakage of oil from the bearings 2, 3 which drops out of the grease which is introduced into the bearing region 4, 5. The oil-collecting element 8, 9 consists of a porous material, e. g. Al₂O₃.

To feed back the dropped out oil from the oil-collecting elements 8, 9 to the bearing region 4, 5 a transport element 10, 11 is arranged. The transport element 10, 11 is e.g. a strip of porous material which transfers the collected oil from the oil-collecting element 8, 9 due to a capillary effect back to the bearing region 4, 5. The transport element 10, 11 consists also of a porous material like e. g. Al₂O₃. The transport element 10, 11 can be located in a cut-in in the housing 15. The number of transport elements 10, 11 is chosen due to the desired effect of feed-back of the oil.

To improve the supply of the bearings 2, 3 with lubricant an oil reservoir 12, 13 is arranged above the bearings 2, 3. In the oil reservoir 12, 13 a certain amount of oil can be kept. In the case that the bearings arrangement 1 is excited with vibrations of a defined magnitude oil is emitted from the oil reservoir 12, 13 to the bearing 2, 3. A typical case of excitation with such vibration is the run up of the bearing arrangement 1. So, in this case a small amount of fresh oil it dispensed from the oil reservoir 12, 13 to the bearing 2, 3.

To survey the operation of the bearing arrangement 1 sensors can be employed. In the depicted embodiment a sensor element 17 and 18 is arranged in the outer ring 23, 25 of the bearings 2, 3 for sensing the temperature and/or the vibration of the bearing. Accordingly, sensor elements 19 and 20 are arranged in the inner rings 24, 26. The further sensor element 21 senses the revolution speed of the shaft element 14 relatively to the housing 15. All sensed parameters are transferred in a wireless way to a survey station 22. The survey station 22 evaluates the received data and can transfer them to a control unit of the drive system of the bearing arrangement (now shown). So, an online-survey of the bearing arrangement becomes possible. If to high vibrations and/or temperatures are detected a shut-down of the arrangement can be triggered.

By the invention the assembly of a separator becomes quite easy which uses the proposed lubrication system. It is guaranteed that the supply with lubricant takes place for a long time, preferably for the whole lifetime of the separator. A re-lubrication is ensured by the oil reservoirs 12, 13 as well as by the oil-collecting elements 8, 9 and the transport elements 10, 11.

The re-lubrication is arranged “on-board”, i. e. no external re-lubrication is necessary. The lubrication takes place by using basically grease instead of oil. The re-lubrication can be triggered by a machine control device (now shown) which can be freely programmed due to the amount of re-lubricating oil and the time of re-lubrication.

The integrated sensor elements allow the survey of e. g. the pre-load in the bearings 2, 3 and the temperature in the bearings 2, 3. The sensed parameters can deliver an information about the lifetime of the lubricant.

It is possible to design the bearing arrangement and the grease filling of the bearings to ensure an efficient lubricating of the bearings arrangement over the whole lifetime of it without any external re-lubrication.

By using steel for the housing 15 and aluminum or magnesium for the shaft element 14 stress due to a different thermal expansion can be prevented.

The porous material 8, 9, 10, 11 can be filled completely with oil after completion of the assembly of the bearing arrangement.

In FIG. 2 an alternative embodiment of the invention is shown. While FIG. 1 employs two bearing 2 and 3, the solution according to FIG. 2 has only one bearing 2.

This means that one or more bearings with a single row or with more than one row of rolling elements can be used according to the invention.

In FIG. 3 the whole separator 31 is depicted, which is driven by a belt drive 33. Here, the bearing arrangement 1 according to FIG. 1 is used, i. e. two bearings 2 and 3 are adjacently arranged on the shaft element 14. The shaft element 14 is hold by a further bearing arrangement 32 which is located with distance to the bearing arrangement 1. This bearing arrangement 32 can be designed according to the invention or conventionally.

Of course, different designs can be used with respect to the arrangement of bearings for holding the shaft element 14 in the housing. There can be a common housing for a plurality of bearing arrangements 1, 32 or different housing parts for the different bearing arrangements.

Further in other embodiments the above described can also be applied in arrangements with other orientations of the shaft, particularly in horizontal shaft arrangements e.g. in decanters.

### LIST OF REFERENCES

1 bearing arrangement
2 grease-lubricated bearing
3 grease-lubricated bearing
4 bearing region
5 bearing region
6 rolling element
7 rolling element
8 oil-collecting element
9 oil-collecting element
10 transport element
11 transport element
12 oil reservoir
13 oil reservoir
14 shaft element
15 housing
16 axis
17 sensor element
18 sensor element
19 sensor element
20 sensor element
21 sensor element
22 survey station
23 outer ring
24 inner ring
25 outer ring
26 inner ring
27 sealing element
28 sealing element
29 sealing element
30 sealing element
31 separator
32 bearing arrangement
33 drive
α angle
β angle

1. A bearing arrangement, comprising:
at least one grease-lubricated bearing with a bearing region,
one of rolling elements and a sliding element disposed within the bearing region,
at least one oil-collecting element disposed proximal to the at least one bearing and configured to collect basis oil of lubrication grease, and
a transport element connecting the oil-collecting element with the bearing region.

2. The bearing arrangement according to claim 1, wherein at least one of the transport element and the oil-collecting element is formed of a porous material.

3. The bearing arrangement according to claim 2, wherein at least one of the transport element and the oil-collecting element is formed of a ceramic material.

4. The bearing arrangement according to claim 2, wherein the porous material includes aluminum oxide (Al₂^{O}₃).

5. The bearing arrangement according to claim 2, wherein the porous material includes zirconium oxide (ZrC₂).

6. The bearing arrangement according to claim 1, further comprising an oil reservoir located proximal to the at least one bearing.

7. (canceled)

8. The bearing arrangement according to claim 6, wherein the oil reservoir is configured to emit oil when the bearing arrangement experiences vibration above a predetermined level.

9. The bearing arrangement according to claim 1, wherein the bearing arrangement further comprises sealing means for sealing the bearing region to prevent leakage of lubricant.

10. The bearing arrangement according to further comprising a housing and a shaft element disposed within the housing, the at least one bearing coupling the shaft with the housing

11. The bearing arrangement according to claim 10, wherein the axis of the shaft element extends generally vertically.

12. The bearing arrangement according to claim 11, wherein the oil-collecting element is located generally below the at least one bearing.

13. The bearing arrangement according to claim 11, wherein the oil reservoir is located generally above the at least one bearing.

14. The bearing arrangement according to claim 10, wherein the shaft element is formed of aluminium and the housing is formed of steel.

15. The bearing arrangement according to claim 1, wherein the at least one bearing includes first and second angular contact bearings.

16. The bearing arrangement according to claim 15, wherein each angular contact ball bearing has a contact angle, the angle of the first bearing being one of greater than and lesser than the angle of the second bearing.

17. The bearing arrangement according to claim 16, wherein the angle of the first angular contact ball bearings is between 10° and 20° and the angle of the second angular contact ball bearings is between 25° and 35°.

18. The bearing arrangement according to claim 1, wherein the at least one bearing has at least one sensor element configured to monitor at least one operation parameter.

19. The bearing arrangement according to claim 18, wherein the at least one sensor element is in wireless contact with a survey station for monitoring the at least one operation parameter.

20-21. (canceled)

22. A separator comprising:
a housing,
a shaft disposed within the housing, and
a bearing arrangement including:
at least one grease-lubricated bearing coupling the shaft with the housing and having a bearing region,
one of a plurality of rolling elements and a sliding element disposed within the bearing region,
at least one oil-collecting element disposed proximal to the at least one bearing and configured to collect basis oil of lubrication grease, and
a transport element connecting the oil-collecting element with the bearing region.

23. A bearing arrangement for use in the food industry, the bearing arrangement comprising:
at least one grease-lubricated bearing coupling the shaft with the housing and having a bearing region,
one of a plurality of rolling elements and a sliding element disposed within the bearing region,
at least one oil-collecting element disposed proximal to the at least one bearing and configured to collect basis oil of lubrication grease, and
a transport element connecting the oil-collecting element with the bearing region.
